(19) United States
(12) Patent Application Publication
(10) Pub. No.: US 2026/0189329 A1
(43) Pub. Date: Jul. 2, 2026

(54) ORTHOGONAL FREQUENCY DIVISION MULTIPLEXING SIGNAL APPARATUS AND METHOD

(71) Applicant: Nokia Solutions and Networks Oy, Espoo (FI)

(72) Inventors: Selahattin GOKCELI, Espoo (FI); Dani Johannes KORPI, Espoo (FI); Karthik UPADHYA, Espoo (FI); Mikko Aleksi UUSITALO, Espoo (FI)

(21) Appl. No.: 19/131,468

(22) PCT Filed: Nov. 22, 2022
(86) PCT No.: PCT/EP2022/082775

§ 371 Date: May 20, 2025

(51) Int. Cl. H04L 5/00; H04L 27/26

(52) U.S. Cl. CPC H04L 5/0007; H04L 27/2634

(57) ABSTRACT

Example embodiments relate to an apparatus and method. The apparatus comprises a means for receiving a first signal data set comprising samples of an orthogonal frequency division multiplexing signal. The orthogonal frequency division multiplexing signal may comprise a plurality of subcarriers. Each sample comprises a sampled phase value. The apparatus further comprises a means for extracting the sampled phase values from each sample in the first signal data set. The apparatus further comprises a means for detecting configured to detect a coherent summation based on the sampled phase values. The apparatus further comprises a means for adjusting the sampled phase values in the first signal data set in the event of a detected coherent summation. The apparatus may be used for reducing the Peak-to-Average Power ratio of an orthogonal frequency division multiplexing signal.

### FIELD

Example embodiments relate to apparatus and methods for Orthogonal Frequency Division Multiplexing (OFDM) signals.

### BACKGROUND

An Orthogonal Frequency Division Multiplexing (OFDM) signal may be used in telecommunications for transmitting data over multiple subcarrier frequencies. The subcarriers are overlapping in frequency but orthogonal to one another to reduce interference between subcarriers. Each subcarrier may be modulated with a modulation scheme such as Quadrature Amplitude Modulation (QAM) or Phase Shift Keying (PSK) to generate data symbols corresponding to the data being transmitted. An OFDM signal may include a Cyclic Prefix. There remains a need for improvements in apparatus and methods for OFDM signals.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising: means for receiving a first signal data set comprising samples of an orthogonal frequency division multiplexing signal, wherein each sample comprises a sampled phase value; means for extracting the sampled phase values from each sample in the first signal data set; means for detecting configured to detect a coherent summation based on the sampled phase values; means for adjusting the sampled phase values in the first signal data set in the event of a detected coherent summation.

In some embodiments, the apparatus further comprises means for calculating an inverse Fourier transform coefficient set of the first signal data set, wherein each inverse Fourier transform coefficient comprises a calculated phase value.

In some embodiments, the apparatus further comprises means for extracting the calculated phase values.

In some embodiments, the means for detecting is configured to detect a coherent summation based on the sampled phase values and the calculated phase values.

In some embodiments, the apparatus further comprises means for grouping the extracted phase values into octants in the complex plane.

In some embodiments, the means for detecting is configured to detect the coherent summation based on a cardinality of each octant.

In some embodiments, the means for detecting is configured to detect the coherent summation based on a sum of the extracted phase values.

In some embodiments, the apparatus further comprises means for calculating a probability of the coherent summation.

In some embodiments, the means for adjusting comprises calculating a noise signal for reducing the probability of the coherent summation when the noise signal is added to the orthogonal frequency division multiplexing signal.

In some embodiments, the noise signal comprises an amplitude based on a target error vector magnitude. The target error vector magnitude may be based on the subcarriers of the OFDM signal.

In some embodiments, the apparatus further comprises means for generating a second signal comprising the noise signal added to the orthogonal frequency division multiplexing signal in the frequency domain.

In some embodiments, the apparatus further comprises means for processing said second signal using: said means for receiving to receive a second signal data set comprising second samples of said second signal, wherein each second sample comprises a second sampled phase value; said means for extracting to extract said second sampled phase values; said means for detecting to detect a second coherent summation based on said second sampled phase values; and said means for adjusting to adjust said second sampled phase values in the second signal data set in the event of a detected second coherent summation.

In some embodiments, the means for detecting comprises a Deep Neural Network or a decision tree-based algorithm.

In some embodiments, the apparatus further comprises means for training the Deep Neural Network or decision tree-based algorithm for example using a binary cross-entropy loss function.

According to a second aspect, there is described a method comprising: receiving a first signal data set comprising samples of an orthogonal frequency division multiplexing signal, wherein each sample comprises a sampled phase value; extracting the sampled phase values from each sample in the first signal data set; detecting to detect a coherent summation based on the sampled phase values; adjusting the sampled phase values in the first signal data set in the event of a detected coherent summation.

In some embodiments, the method further comprises calculating an inverse Fourier transform coefficient set of the first signal data set, wherein each inverse Fourier transform coefficient comprises a calculated phase value.

In some embodiments, the method further comprises extracting the calculated phase values.

In some embodiments, the step of detecting is configured to detect a coherent summation based on the sampled phase values and the calculated phase values.

In some embodiments, the method further comprises grouping the extracted phase values into octants in the complex plane.

In some embodiments, the step of detecting is configured to detect the coherent summation based on a cardinality of each octant.

In some embodiments, the step of detecting is configured to detect the coherent summation based on a sum of the extracted phase values.

In some embodiments, the method further comprises calculating a probability of the coherent summation.

In some embodiments, the step of adjusting comprises calculating a noise signal for reducing the probability of the coherent summation when the noise signal is added to the orthogonal frequency division multiplexing signal.

In some embodiments, the noise signal comprises an amplitude based on a target error vector magnitude.

In some embodiments, the method further comprises generating a second signal comprising the noise signal added to the orthogonal frequency division multiplexing signal in the frequency domain.

In some embodiments, the method further comprises processing said second signal using: receiving to receive a second signal data set comprising second samples of said second signal, wherein each second sample comprises a second sampled phase value; extracting to extract said second sampled phase values detecting to detect a second coherent summation based on said second sampled phase values; and adjusting to adjust said second sampled phase values in the second signal data set in the event of a detected second coherent summation.

In some embodiments, the step of detecting comprises a Deep Neural Network or a decision tree-based algorithm.

According to a third aspect, there is provided a computer program product comprising a set of instructions which, when executed on an apparatus, is configured to cause the apparatus to carry out the method of receiving a first signal data set comprising samples of an orthogonal frequency division multiplexing signal, wherein each sample comprises a sampled phase value; extracting the sampled phase values from each sample in the first signal data set; detecting to detect a coherent summation based on the sampled phase values; adjusting the sampled phase values in the first signal data set in the event of a detected coherent summation.

Optional features of the third aspect may comprise any feature of the second aspect.

According to a fourth aspect, there is provided a non-transitory computer readable medium comprising program instructions stored thereon for performing a method, comprising: receiving a first signal data set comprising samples of an orthogonal frequency division multiplexing signal, wherein each sample comprises a sampled phase value; extracting the sampled phase values from each sample in the first signal data set; detecting to detect a coherent summation based on the sampled phase values; adjusting the sampled phase values in the first signal data set in the event of a detected coherent summation.

The program instructions of the fourth aspect may also perform operations according to any preceding method definition of the second aspect.

According to a fifth aspect, there is provided an apparatus comprising: at least one processor; and at least one memory including computer program code which, when executed by the at least one processor, cause the apparatus to: receive a first signal data set comprising samples of an orthogonal frequency division multiplexing signal, wherein each sample comprises a sampled phase value; extract the sampled phase values from each sample in the first signal data set; detect to detect a coherent summation based on the sampled phase values; adjust the sampled phase values in the first signal data set in the event of a detected coherent summation.

The computer program code of the fifth aspect may also perform operations according to any preceding method definition of the second aspect.

### BRIEF DESCRIPTION OF THE DRAWINGS

Example embodiments will now be described by way of non-limiting example, with reference to the accompanying drawings, in which:

FIG. 1 is a flow diagram indicating processing operations that may be performed by an apparatus in accordance with an example embodiment;

FIG. 2 illustrates an apparatus in accordance with an example embodiment;

FIG. 3 illustrates an apparatus in accordance with an example embodiment;

FIG. 4 is a plot illustrating an example of octants in the complex plane;

FIG. 5 illustrates an apparatus in accordance with an example embodiment;

FIG. 6 illustrates a block diagram of a training procedure for a Machine Learning model in accordance with an example embodiment;

FIG. 7 shows an apparatus according to some example embodiments;

FIG. 8 shows a non-transitory media according to some embodiments.

### DETAILED DESCRIPTION

The scope of protection sought for various embodiments of the disclosure is set out by the independent claims. The embodiments and features, if any, described in the specification that do not fall under the scope of the independent claims are to be interpreted as examples useful for understanding various embodiments of the disclosure.

Energy efficiency and spectral efficiency are important for next-generation wireless networks due to increasing demand and emerging challenges together with growing networks. In line with these, the high carrier frequencies have great potential as these are currently not utilized and can offer high capacity and data rate. Accordingly, carrier frequencies up to 52.6 GHz are supported by the existing 3GPP standardization, which refers to 5G NR Rel-15.

On the other hand, frequencies above this level are being studied by 3GPP RAN as well and it is expected that these will be integral part of the future 6G specifications.

Some of the potential mm-wave bands to be introduced for 5G and beyond are 70/80/92-114 GHz. The ongoing study items on such frequency ranges that are mainly related to physical layer and waveform design for operation above 52.6 GHz, consider the following aspects:
Efficient transceiver design, including power efficiency and complexity;
Improvement of coverage to cope with extreme propagation loss;
Inheriting physical layer channel design for below 52.6 GHz from NR Rel-15 WI whenever applicable.

Some challenging problems of such high frequencies are higher path loss and hardware problems due to RF components such as power amplifiers (PAs). Thus, higher PA efficiency and transmission power are beneficial for good performance. In addition, the terahertz-frequency bands may be beneficial in 6G due to an increase in the available spectrum and associated benefits.

PA efficiency may be associated with the Peak-to-Average Power Ratio (PAPR) of the input signal to the PA. Some types of OFDM waveforms, such as Cyclic Prefix (CP) OFDM (which is a primary waveform of the physical layer of 5GNR), can have a high PAPR which affects the PA efficiency.

High amplitude peaks may occur in a time domain summation of the subcarriers of an OFDM signal where there is a coherent summation of phases. A coherent summation may occur when the phases of the subcarriers are similar for a given sample. The similar phase values coherently sum (for example after applying an Inverse Fast Fourier Transform (IFFT) or Inverse Discrete Fourier Transform (IDFT) function to the samples) thus producing an amplitude peak. The phase values of the samples of the subcarriers may be determined by a data symbol of the subcarrier (e.g. a QAM or PSK data symbol). For example, an IFFT operation would lead to a coherent summation of these symbols for certain time-domain indices if corresponding IFFT coefficients lead to similar phase values for each QAM symbol.

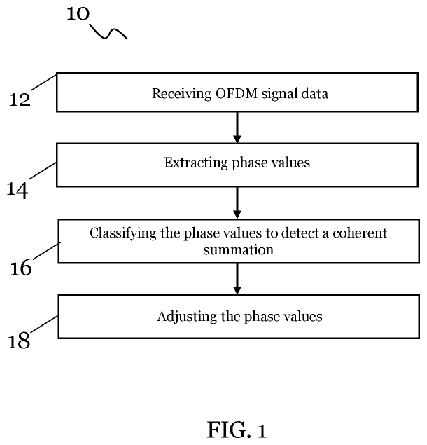

FIG. 1 is a flow diagram indicating processing operations 10 that may be performed by an apparatus in accordance with an example embodiment. The processing operations 10 may be performed by hardware, software, firmware or a combination thereof.

A first operation 12 comprises receiving a first signal data set comprising samples of an orthogonal frequency division multiplexing (OFDM) signal, wherein each sample comprises a sampled phase value. Each sample may be a complex waveform. In some embodiments, a complex waveform may be in the frequency domain. In other embodiments, a complex waveform may be in the time domain. The OFDM signal may comprise a plurality of subcarriers. Each subcarrier may comprise one or more data symbols for example a QAM or PSK data symbol.

A second operation 14 comprises extracting the sampled phase values from each sample in the first signal data set.

A third operation 16 comprises detecting to detect a coherent summation based on the extracted sampled phase values. In some example embodiments, detecting may involve using a classifying algorithm such as a machine learning algorithm.

A fourth operation 18 comprises adjusting the sampled phase values in the first signal data set in the event of a detected coherent summation.

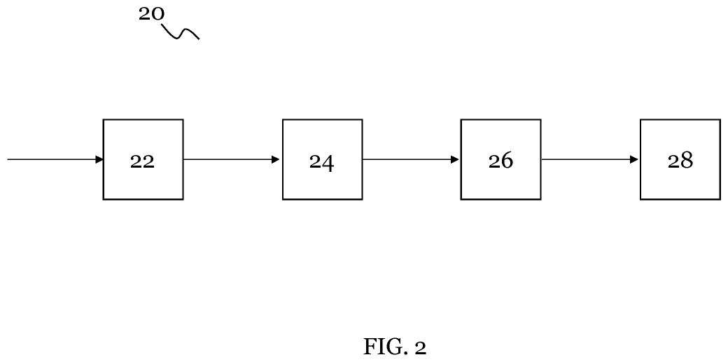

FIG. 2 illustrates an apparatus 20 in accordance with an example embodiment. The apparatus 20 comprises a means for receiving 22 a first signal data set comprising samples of an orthogonal frequency division multiplexing signal. Each sample in the first signal data set comprises a complex waveform comprising a sampled phase values.

The apparatus 20 further comprises a means for extracting 24 the sampled phase values from each sample in the first signal data set.

The apparatus 20 further comprises a means for detecting 26. The means for detecting 26 is configured to detect a coherent summation based on the extracted sampled phase values.

The apparatus 20 further comprises a means for adjusting 28 the phase values in the orthogonal frequency division multiplexing signal in the event of a detected coherent summation.

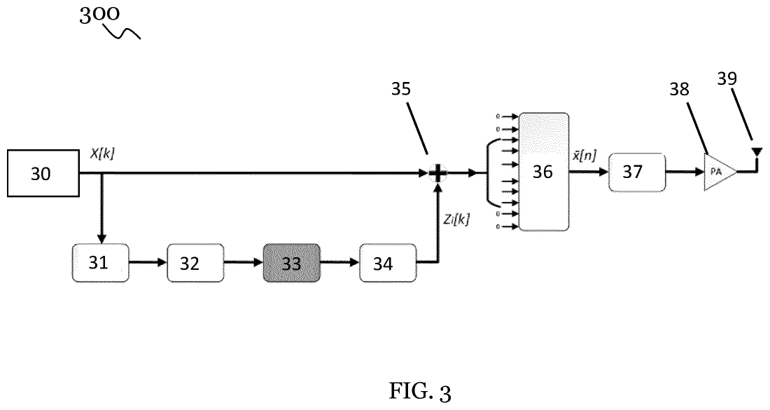

FIG. 3 illustrates an apparatus 300 in accordance with an example embodiment. The apparatus 300 may comprise a general computer or digital signal processing chip. The apparatus 300 comprises a receiving module 30 configured to sample an orthogonal frequency division multiplexing signal to generate a first signal data set. Each sample in the first signal data set comprises a complex waveform in the frequency domain comprising a sampled phase value. The first signal data set may be generated by a processor in a device such as a mobile phone. The OFDM signal may comprise a plurality of subcarriers which may each contain one or more data symbols. The data symbols may be QAM, PSK or other types of digital signal modulations. The data symbols may be part of a telecommunications signal such as 4G, 5G or 6G etc. The means for receiving 30 the first signal data set may comprise a digital signal processor for receiving the first signal data set.

The nth sample of time-domain OFDM waveform can be denoted as

$$x [ n ] = \frac{1}{\sqrt{N}} {\sum }_{k = - {N}_{a c t} / 2}^{{N}_{a c t} / 2 - 1} X [ k ] {e}^{\frac{j 2 π k n}{N}} , \qquad ( 1 )$$

where k is the active subcarrier index with k∈{−N_{act}/2, −N_{act}/2+1, . . . , N_{act}/2−1}, and X[k] is the kth data symbol in frequency domain. Moreover, N is the total number of samples, N_{act} is the total number of active subcarriers.

The apparatus 300 further comprises an IDFT module 36 configured to generate a time domain summation waveform of the k subcarriers X̅[n]. The time domain summation waveform X̅[n] is transferred to a CP addition module 37. This procedure can be expressed by using matrix notation as

$$x = vec ( {TW}^{- 1} X ) , \qquad ( 2 )$$

where X, W⁻¹, and T represent the N×S frequency-domain data symbol matrix with S data symbols, N×N IDFT matrix, and (N+N_{CP})× N CP insertion matrix, respectively. Moreover, vec(⋅) denotes the vectorization operation.

The signal X is the passed through a PA 38 before transmission from an antenna 39.

The apparatus 300 further comprises an extracting module 31 configured to extract the sampled phase value from each sample in the first signal data set.

The extracting module 31 may be further configured to calculate an inverse Fourier transform coefficient module of a signal data set (such as the first signal data set). For example, the module 31 may be configured to calculate W⁻¹.

In some embodiments, the phase values of the time domain signal θₙ [k] may then be calculated from X and W⁻¹ such as using equation 3. Since the phase value of product of two complex numbers can be represented as the addition of individual phase values, the following definition can be made for the multiplication of data symbols and IFFT coefficients for the nth time-domain sample and sth data symbol

$${θ}_{n} [ k ] = ∠ ( {W}_{n} [ k ] ) + ∠ ( {X}_{s} [ k ] ) , \qquad ( 3 )$$

where, Wₙ and Xₛ represent the nth row vector of W⁻¹ and sth row vector of X^{T}, respectively. And as a reminder, index k denotes subcarriers within a data symbol. As seen, phase values of two matrices are summed in (3) to obtain the phase values of the multiplication outputs that can be obtained by multiplying the Wₙ and sth column vector of X.

In some embodiments, the apparatus 300 further comprises an octant generator module 32 configured to group the obtained phase values in octants.

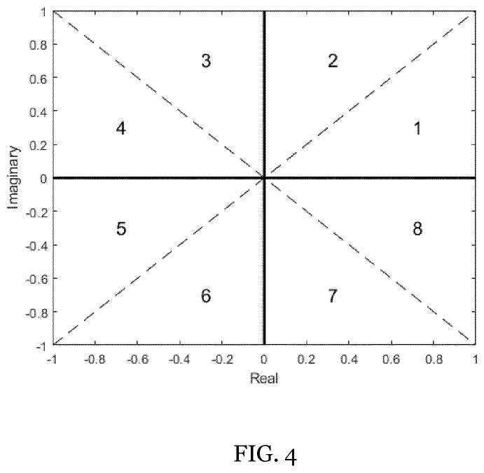

FIG. 4 is a plot illustrating an example of octants in the complex plane. Accordingly, for each octant, a set that contains subcarrier indices is created as

$$\begin{matrix}k \to {κ}_{n , j} , & if \frac{( j - 1 ) π}{4} < {θ}_{n} [ k ] \leq \frac{j π}{4}\end{matrix} , \qquad ( 4 )$$

where j∈{1, 2, . . . ,7, 8} and → denotes the assignment operator. Moreover, θₙ [k] is the kth element of θₙ. In some embodiments, there are eight different sets corresponding to octants shown in FIG. 4 and the subcarrier indices may be assigned to the sets based on the phase values obtained with (3). Once these sets have been created, the cardinality (number of elements in a set) may be computed for each set.

For each data symbol and nth time sample, the vector that consists of cardinality of each sample set may be created as

$${c}_{n} = \{ card ( {κ}_{n , 1} ) , card ( {κ}_{n , 2} ) , … , card ( {κ}_{n , 7} ) , c a r d ( {κ}_{n , 8} ) \} , \qquad ( 5 )$$

where card(⋅) denotes the cardinality of the set.

The apparatus 300 further comprises a trained Machine Learning (ML) model 34. The ML model 33 may be a classifier such as a Deep Neural Network or a decision tree-based algorithm.

In some embodiments, the ML model 33 is configured to receive the extracted phase values for each sample and compute a probability level for a potential coherent summation resulting in an amplitude peak in the time domain.

In some embodiments, the ML model 33 is configured to detect a potential coherent summation based on a sum of the extracted phase values.

In some embodiments, the ML model 33 is configured to receive the octants for each sample and computes the probability level for a potential coherent summation resulting in an amplitude peak in the time domain. This architecture may be mathematically represented as

$$\hat{r} [ n ] = ⌊ f ( {c}_{n} ) ⌉ , \qquad ( 6 )$$

where f(⋅) represents the ML model and └ . . . ┐ denotes the rounding operation.

In some embodiments, the ML model may compute a probability level of peak occurring at time domain sample index n.

In some embodiments, a probability level is normalized to 0 or 1 as it in the range of 0 to 1. For example, \hat{r}[n] represents a predicted normalized value or label, with r[n] is the actual label for the nth sample. If normalized value is equal to 1, it means there is probably of a large time-domain peak at time index n. In line with this, the set that contains the time sample indices with potential peaks may be created as

$$\begin{matrix}n \to {κ}_{p} , & if \hat{r} [ n ] = 1.\end{matrix} \qquad ( 7 )$$

In some embodiments, the apparatus 300 further comprises a clipping noise generation module 34. The clipping noise generation module 34 may be configured to generate a clipping noise signal that, when added to the OFDM signal X[k], will distort the phase values to reduce the probability of a coherent summation and consequently reduce the probability of an amplitude peak in the time domain summation.

In some embodiments, the amplitude of the clipping noise is computed by directly computing the peak values through vector multiplication of corresponding IDFT vectors and the data symbol vector.

In some embodiments, the amplitude of the clipping noise signal comprises an amplitude based on a target Error Vector Magnitude (EVM) for the subcarriers.

In some embodiments, the amplitude of the clipping noise signal comprises a predetermined amplitude.

The clipping noise for the ith peak and kth subcarrier may be configured as

$${Z}_{i} [ k ] = {A}_{i} {e}^{- {\sum }_{k} {θ}_{{κ}_{p} [ i ]} [ k ] - \frac{j 2 π k n}{N}} , \qquad ( 8 )$$

where Aᵢ denotes the amplitude level determined based on the EVM limit and number of peaks. The term Σₖ θ_{κ}_{ₚ}_{[i]}[k] is equal to phase value of the corresponding time-domain peak, i.e. Σₖ θₖ_{ₚ}_{[i]}[k]=∠(x[κₚ[i]). In the IFFT operation, since the phase value of the associated IFFT coefficient is equal to

$$\frac{j 2 π k n}{N} ,$$

the term

$$- \frac{j 2 π k n}{N}$$

in the equation is cancelled because of the multiplication. This way, all N_{act} terms have the same phase value at the end of the element-wise multiplication. For the ith peak, the nth (n=κₚ[i]) time-domain sample of the clipping noise may be obtained as

$${z}_{i} [ n ] = \frac{1}{\sqrt{N}} {\sum }_{k = - {N}_{a c t} / 2}^{{N}_{act} / 2 - 1} {A}_{i} {e}^{- {\sum }_{k} {θ}_{{κ}_{p} [ i ]} [ k ]} \qquad ( 9 )$$

The phase value may be configured to generate a negative of a peak at the IFFT output.

The apparatus 300 may further comprise an adding module 35 arranged to add the clipping noise signal zᵢ[k] to the OFDM signal X[k] in the frequency domain. This signal may be passed through an IDFT module 36 to generate a time domain summation signal represented by the following expression

$$\overline{x} [ n ] = \frac{1}{\sqrt{N}} {\sum }_{k = - {N}_{a c t} / 2}^{{N}_{a c t} / 2 - 1} ( X [ k ] + {\sum }_{i ∈ {κ}_{p}} {Z}_{i} [ k ] ) {e}^{\frac{j 2 π k n}{N}} . \qquad ( 10 )$$

Here, the signal X[k] may be modified in accordance with all of the detected time-domain peaks. Then, all these individual samples may be summed as Σ_{i∈κ}_{ₚ}Zᵢ[k]. If there is only one peak, then this is equal to Zᵢ[k]. Moreover, the value of Σ_{i∈κ}_{ₚ} Aᵢ[k] may be less than or equal to the EVM limit.

In some embodiments, the apparatus 300 further comprises a CP addition module configured to apply a CP to the output signal X̅[n] for example as shown in (2) above. The apparatus 300 may further comprise a PA 38 and an antenna 39 for transmitting the OFDM signal.

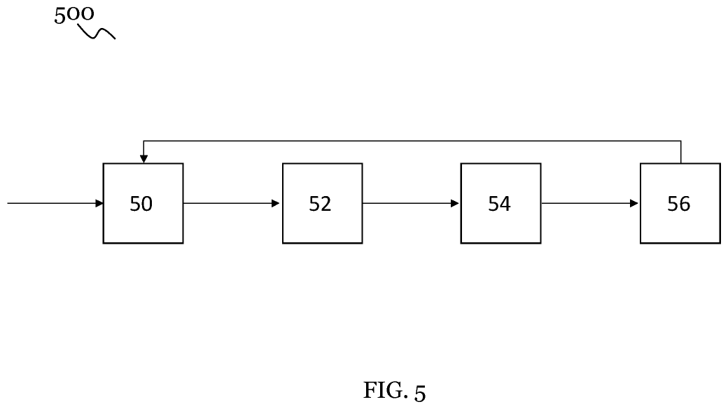

FIG. 5 illustrates an apparatus 500 in accordance with an example embodiment. The apparatus 500 comprises a means for receiving 50 a first signal data set comprising samples of a first orthogonal frequency division multiplexing signal. Each sample in the first signal data set comprises a complex waveform in the frequency domain comprising a sampled phase value.

The apparatus 500 further comprises a means for extracting 52 the sampled phase value from each sample in the first signal data set.

The apparatus 500 further comprises a means for detecting 54. The means for detecting 54 is configured to detect a coherent summation based on the extracted sampled phase values.

The apparatus 500 further comprises a means for adjusting 56 the sampled phase values in the orthogonal frequency division multiplexing signal in the event of a detected coherent summation. The means for adjusting 56 may generate a second signal comprising the adjusted signal. In some embodiments, the second signal is a noise signal added to the first orthogonal frequency division multiplexing signal in the frequency domain.

The apparatus 500 further comprises a means for receiving a second signal data set comprising samples of the second signal. In some embodiments, the means for receiving the first signal data set 50 is also configured to receive the second signal data set. In some embodiments, the output of the means for adjusting 56 is fed into the means for receiving 50 as a feedback loop.

The apparatus 500 further comprises means for processing the second signal using: said means for receiving 50 to receive a second signal data set comprising second samples of said second signal, wherein each second sample comprises a second sampled phase value; said means for extracting 52 to extract said second sampled phase values in said second signal data set; said means for detecting 54 to detect a second coherent summation based on said extracted second sampled phase values in said second signal data set; and said means for adjusting 56 to adjust said second sampled phase values in the event of a detected second coherent summation.

In the training of a ML model, the following binary cross-entropy loss function is considered

$${ℒ}_{B C E} ( r , \hat{r} ) = - {\sum }_{n} r [ n ] log ( \hat{r} [ n ] ) + ( 1 - r [ n ] ) ( 1 - log ( \hat{r} [ n ] ) ) . \qquad ( 11 )$$

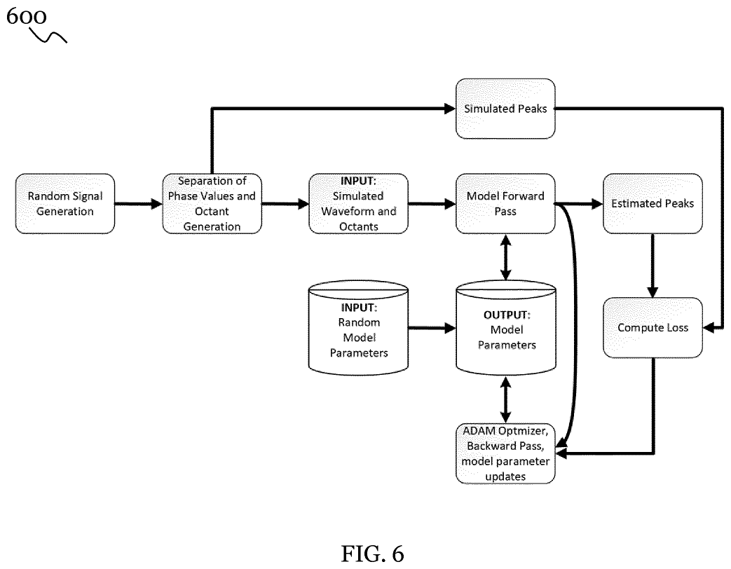

FIG. 6 illustrates a block diagram 600 of a training procedure for a ML model in accordance with an example embodiment. Firstly, signals may be randomly generated and the phase values of the randomly generated signals may be separated to generate the octants. Then, the inputs required for the ML model, such as cardinality of each octant set, may be supplied to a Model Forward Pass function. The actual labels may be set based on the peaks in the simulated data signals for the ML model. In the beginning of the training, random model parameters may be utilized and as the result of forward pass, estimated peaks may be obtained. At the end of each iteration, the loss may be computed for the peaks estimated by the model by comparing them against the simulated peaks. Through forward and backward pass, model parameters may be optimized using the ADAM optimizer. This way, at the end of the iterative process, the trained model is obtained.

### Example Apparatus

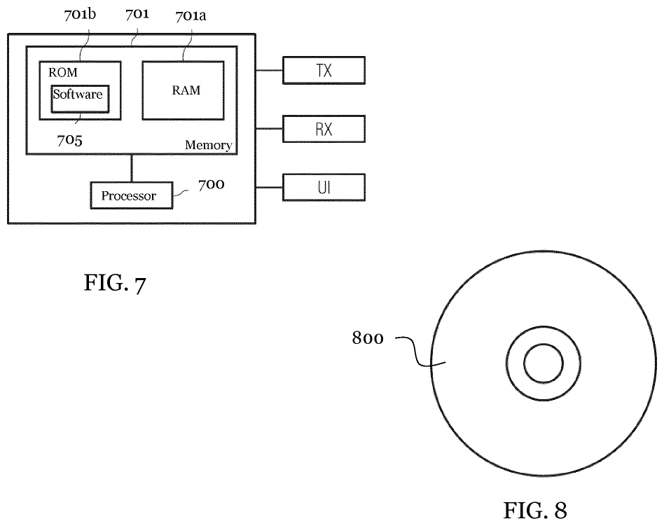

FIG. 7 shows an apparatus according to some example embodiments. The apparatus may be configured to perform the operations described herein, for example operations described with reference to any disclosed process. The apparatus comprises at least one processor 700 and at least one memory 701 directly or closely connected to the processor. The memory 701 includes at least one random access memory (RAM) 701a and at least one read-only memory (ROM) 701b. Computer program code (software) 705 is stored in the ROM 701b. The apparatus may be connected to a transmitter (TX) and a receiver (RX). The apparatus may, optionally, be connected with a user interface (UI) for instructing the apparatus and/or for outputting data. The at least one processor 700, with the at least one memory 701 and the computer program code 705 are arranged to cause the apparatus to at least perform at least the method according to any preceding process, for example as disclosed in relation to the flow diagrams of FIG. 1 and related features thereof.

FIG. 8 shows a non-transitory media 800 according to some embodiments. The non-transitory media 800 is a computer readable storage medium. It may be e.g. a CD, a DVD, a USB stick, a blue ray disk, etc. The non-transitory media 800 stores computer program code, causing an apparatus to perform the method of any preceding process for example as disclosed in relation to the flow diagrams and related features thereof.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as WiFi.

A memory may be volatile or non-volatile. It may be e.g. a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1. An apparatus comprising at least one processor, and at least one memory comprising computer program code which, when executed by the at least one processor, cause the apparatus to:
receive a first signal data set comprising samples of an orthogonal frequency division multiplexing signal, wherein each sample comprises a sampled phase value;
extract the sampled phase values from each sample in the first signal data set;
detect a coherent summation based on the sampled phase values;
adjust the sampled phase values in the first signal data set in the event of a detected coherent summation.

2. The apparatus according to claim 1, wherein the at least one processor, with the at least one memory and the computer program code, cause the apparatus further to calculate an inverse Fourier transform coefficient set of the first signal data set, wherein each inverse Fourier transform coefficient comprises a calculated phase value.

3. The apparatus according to claim 2, wherein the at least one processor, with the at least one memory and the computer program code, causes the apparatus further to extract the calculated phase values.

4. The apparatus according to claim 3, wherein wherein the at least one processor, with the at least one memory and the computer program code, is configured to detect a coherent summation based on the sampled phase values and the calculated phase values.

5. The apparatus according to claim 1, wherein the at least one processor, with the at least one memory and the computer program code, causes the apparatus further to group the extracted phase values into octants in the complex plane.

6. The apparatus according to claim 5, wherein the at least one processor, with the at least one memory and the computer program code, is configured to detect the coherent summation based on a cardinality of each octant.

7. The apparatus according to claim 1, wherein the at least one processor, with the at least one memory and the computer program code, is configured to detect the coherent summation based on a sum of the extracted phase values.

8. The apparatus according to claim 1, wherein the at least one processor, with the at least one memory and the computer program code, causes the apparatus further to calculate a probability of the coherent summation.

9. The apparatus according to claim 1, wherein the adjusting comprises calculating a noise signal for reducing the probability of the coherent summation when the noise signal is added to the orthogonal frequency division multiplexing signal.

10. The apparatus according to claim 9, wherein the noise signal comprises an amplitude based on a target error vector magnitude.

11. The apparatus according to claim 9, wherein the at least one processor, with the at least one memory and the computer program code, causes the apparatus further to generate a second signal comprising the noise signal added to the orthogonal frequency division multiplexing signal in the frequency domain.

12. The apparatus according to claim 11, wherein the at least one processor, with the at least one memory and the computer program code, causes the apparatus further to process said second signal by:
receiving a second signal data set comprising second samples of said second signal, wherein each second sample comprises a second sampled phase value;
extracting said second sampled phase values;
detecting a second coherent summation based on said second sampled phase values; and
adjusting said second sampled phase values in the second signal data set in the event of a detected second coherent summation.

13. The apparatus according to claim 1, wherein the detecting comprises detecting using a Deep Neural Network or a decision tree-based algorithm.

14. The apparatus according to claim 13, wherein the at least one processor, with the at least one memory and the computer program code, causes the apparatus further to train the Deep Neural Network or decision tree-based algorithm using a binary cross-entropy loss function.

15. A method comprising:
receiving a first signal data set comprising samples of an orthogonal frequency division multiplexing signal, wherein each sample comprises a sampled phase value;
extracting the sampled phase values from each sample in the first signal data set;
detecting a coherent summation based on the sampled phase values;
adjusting the sampled phase values in the first signal data set in the event of a detected coherent summation.
